(19) United States
(12) Patent Application Publication
(10) Pub. No.: US 2020/0208808 A1
(43) Pub. Date: Jul. 2, 2020

(54) METHOD FOR FORMING COVERAGE DISCRETE SOLID ANGLE LIGHT BEAM

(71) Applicant: Ercan Arslan, Antalya (TR)

(72) Inventor: Ercan Arslan, Antalya (TR)

(21) Appl. No.: 16/634,154

(22) PCT Filed: Jul. 26, 2017
(86) PCT No.: PCT/TR2017/050346

§ 371 Date: Jan. 26, 2020

(51) Int. Cl. F21V 11/16

(52) U.S. Cl. CPC F21V 11/16; F21Y 2107/10

(57) ABSTRACT

This invention concerns a method for forming Coverage Discrete Solid Angle Light Beam that satisfies the criteria for forming an ideal illumination such as covering of the basic illumination area within its borders by means of the quadrilaterallight spot, achieving homogenous light density, illuminance and luminance levels in related area besides quadrilateral covering of target illumination area, the ability to use all of the light flux produced by the source only within target illumination area and protecting environment from light pollution in this way and offers the possibility to be able to regulate the photometric values of the solid angle created and the flux it carries within itself based on the target illumination area.

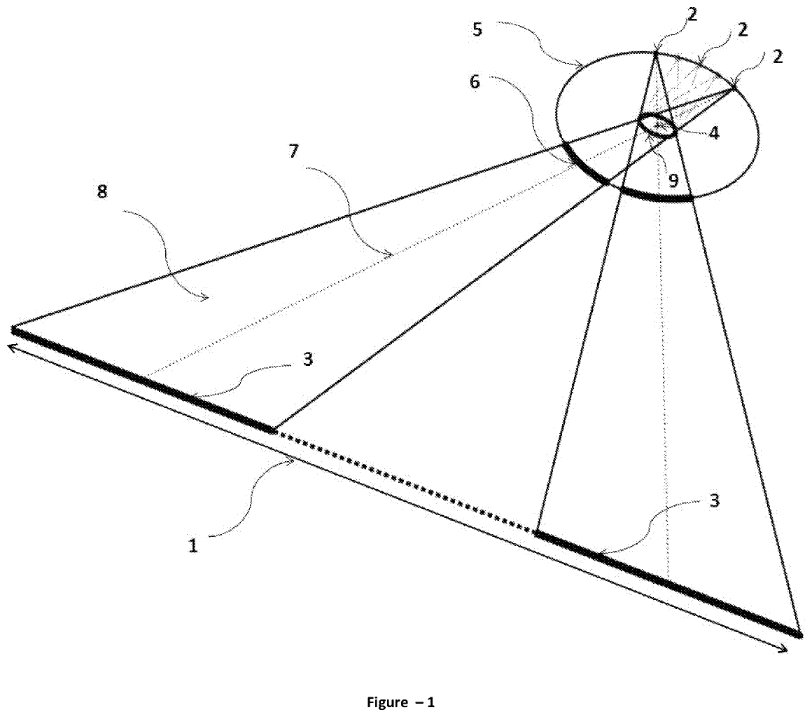

### TECHNICAL AREA

This invention is related to the method for forming Discrete Solid Angle Light Beam that offers possibility to be able to regulate the solid angle beam obtained and the photometric values it carries within it according to target illumination target area, having the specifications to meet criteria like giving opportunity for rectangular illumination-covering of basic illumination area within its borders via a rectangular spot, achieving homogenous light density, illuminance and luminance levels in related region as well as tetragonal covering of target space, constituting uninterrupted integrated illumination by illuminated tetragonal areas through merging in modular structure without leaving any dark or weak illumination region between them, using all of light flux produced by source only within target illumination area, so protecting environment from light pollution, solving glare problem by not appearing outside the space that source involves, etc. in order to create an ideal illumination.

### Former Technique

Lack of target area illumination in current illuminations causes scattering of light outside usage target illumination area, illumination of environment out of target and formation of light pollution.

In existing illuminations, no homogenous light density, distribution of illuminance and luminance levels are available. Current lighting fixtures cannot form an uninterrupted integrated illumination too as they do not create tetragonal light spot. On the other hand, present lighting fixtures (LED or conventional lighting fixtures) shine out of basic target illumination area; which means that it appears outside of the target illumination coverage. They also create glaring problem because their appearance outside of target illumination coverage. Many of these drawbacks are serious problems with current lighting and present lighting fixtures.

Description of Ideal Illumination to be Acquired to Illumination Sector with this Invention and the Criteria for Ideal Illumination

“Ideal Illumination is the one in which sufficient light is produced, produced light is only used in basic target illumination area, requirements of key illumination space is met optimum within standards by consuming minimum energy, equal illuminance and even luminance levels are obtained by evenly distributing light intensity within basic illumination area, besides, no weak light or dark regions remain within key illumination coverage area, tetragonal light spots falling on the basic illumination area combine each other with the tetragonal modular structure to make integrated, uninterrupted and homogeneous illumination, sufficient light production targets only basic illumination area and reference surface (17-1057 reference surface CIE), no light pollution exists since no leakage light out of target and besides, and direct glare (17-317 direct glare CIE) are absent since light sources not seen within their own scope”

In addition to that, description of ideal illumination is made by means of determination of current illumination problems, solution of these, as new meanings they bring sector in terms of quality and comfort. Namely, ideal illumination also gives solution findings of experienced current problems following detection of illumination requirements. The criteria for ideal illumination are solution of all problems which are seen in existing illumination.

Objective of our invention is to form basic light beam of lighting fixtures with discrete unit light beams in order to actualise criteria for ideal illumination. This invention concern a discrete main light beam of a lighting fixture, that discrete main light beam consists of unit beams, unit light beams that unit light sources carried on this lighting fixture produces, each one looks at its own target in different directions for desired action.

Light flux produced by a lighting fixture goes toward basic target illumination area or the objects desired to be illuminated within the main light beam it has got. Optic perception or illumination (17-559 illumination CI) in another sense is realized with striking of lights on eyes by reflection of lights from.

Structure of the main light beam of a lighting fixture carries whole properties of the illumination to be done. In brief, main light beams designate the properties of targeted illumination type. As regards an illumination, in order to obtain desired criteria, it is essential to bring the properties to meet desired criteria in the main light beams.

Solid angle (17-1201 solid angle (of an area subtended at a point) CIE) is measure of divergence from each other as from common point where planes more than three intersects; in three dimensional space, it is the ratio of the visible area that solids cover towards point center to the sphere diameter of projective radial area that it constituted on the sphere with common center.

Total light flux (17-1323 total flux (of a source) CIE) is carried in main light beam to target after being generated by illumination tool (at source). Photometrical dimension for travel of a light beam to target (17-914 photometry CIE) becomes with the help of solid angle it carries therein. The part of space shaped by solid angle wherein total light flux moves forward is referred to solid angle light beam or space angle too. Here, solid angle light beam is also used in the meaning of main light beam as well.

Geometrical and optical structure of a solid angle's light beam which will meet criteria for ideal illumination takes shape and properties according to each criterion. In this meaning, to make a “modular and uninterrupted” illumination coverage, the beam to be used should be able to create “tetragonal spot” on the main target illumination area, and to achieve that, the geometrical shape that beam will take should have “5” faced pyramidal (penta hedragonal) structure. Projection appearance of the basic illumination area to be illuminated should be the same with the projection appearance on the sphere according to center of sphere at the lower surface in the center of solid angle forming sphere which is constituted according to intersection point of central light beams at the peak point (apex) of pyramid. If and only if, a solid angle light beam having this structure may only be made with “coverage of targeted illumination area” and again, thanks to that, “a tetragonal spot” may be created on target area. Light beam in this geometrical structure is called “coverage solid angle light beam”

On the other hand, the total light flux emitted from an illumination source is equally distributed in “coverage solid angle light beam” carried; this light beam reaches “property of uniform light density distribution”. Thanks to light beams wherein uniform light intensity distribution exists, illumination having equal light density occurs on targeted area. Again, equal tetragonal areas covered with equal light intensity are fit for full merging without leaving any void among them geometrically. With these properties, tetragonal areas realize “uninterrupted integrated” illumination at the same intensity by merging without having a break to illumination. In addition, the lighting fixtures having coverage solid angle beam that cover only their target illumination area do not irradiate outside, they are not seen “outside their coverage”. The light sources (lighting fixtures) which are not appeared outside their coverage (outside target space) do not also create “direct glaring” problem as well as their efficiency.

### Status of Our Invention Against Current Technical Developments in the World

Only one method known about this matter in the World is available for use of all light flux produced from direct lighting (17-319 direct lighting CIE) only in target illumination area, in other sense for capability to send it in target illumination area. With this method, it is tried to make light distribution via secondary optics having special design (the optic making direction of the light emitted only from source used after LED-source; 17-1147 secondary light source CIE). However, failing to constitute optical efficiency and lighting with uniform distribution is disadvantage of the current method. Because, light intensity emission of the source change depending on lateral angle to main axis (17-632 Lambert's Cosine law CIE). As the light sources-LED deployed on current lighting fixtures place only on single plane, unit light beams have also single emission axis (planar normal of the plane where they are positioned on) and cannot direct the beams they emit (secondary optics) to different directions due to that reason, they cannot create uniform distribution on basic target area.

As a result of unified property of “discrete solid angle light beam” that is subject matter of the invention the capability of making uniform light distribution (uniformity) will be acquired to “coverage discrete solid angle light beam”. Discrete solid angle light beam of a lighting fixture subject to the invention has got is made up of unit light beams that possess multiple different flux values and different sized solid angles together with different emission directions. Besides, the light flux carried in the unit beams which constitute this coverage discrete solid angle light beam has got uniform intensity with other ones so that they create uniform light intensity on their targets. As unit beams composing discrete solid angle light beam in the invention has varied direction, (in different emission axes), they are not affected from Lambert's Cosine Law.

Here, in an illumination made with “coverage discrete solid angle light beams” having unit light beams with multiple and different emission axis mentioned in the invention, success of uniform light intensity distribution for illumination is obtained with high light usage efficiency on target. Compared to that, with regard to the illumination made with current technique (lighting method in which the secondary optics having single emission axis is used), it cannot also be mentioned about uniform intensity distribution of the light intensity together with low rate of light flux falling on target.

With the aim of exemplifying as unit light source used for mentioning invention, LED is preferred. In LED illumination tools, “unit light source” means LED (17-648 light emitting diode CIE).

The light beam that single light source (LED) produced with secondary optics is referred to “unit light beam”. Since unit light sources deploying on a single plane (with two dimensions) in the lighting fixture creates their unit light beams in the same emission direction and unit light beams with the same emission axis come together to form the main light beam of the lighting fixture. So two dimensional lighting also occurs. In other sense, main light beam of a two-dimensional lighting fixture consists of merging of unit light beams with the same axis generated by unit light sources which are deployed on a single plane in the lighting fixture. On the contrary, unit light sources deployed on multiple planes (with three dimensions) constitute a main “discrete solid angle light beam” with their unit light beams that keep different unit solid angles and the different emission directions that they produce. In other sense, the main “discrete solid angle light beam” of a three dimensional lighting fixture is made up of combinations completing each other, the light beams which have got different radiation axes and different solid angles produced by unit light sources deployed on multiple planes.

A discrete solid angle light beam consists of unit light beams as that the number of unit light source (i.e. LED) on a polyhedral lighting fixture that it belongs to. Unit light beams with uniform light intensity and different emission axes which are mentioned in this invention covers the illumination area they target via uniform light intensity distribution.

The coverage discrete solid angle light beam composed of unit light beams that carry uniform light intensity within its solid angle and having different emission axes illuminates lighting area it targets by means of unit light beams holding uniform light intensity.

The light beam that consists of multiple unit light beams with different emission directions, unit beams keep uniform flux density and distribution, the total flux it moves in solid angle in this manner have uniform intensity distribution, possess “5” side pyramid (penta hedragonal) structure, contain a design to project main illumination area targeted by geometrical shape of its lower face looking at target (space with perspective view), thus cover the area it aims, create tetragonal spot with uniform intensity on basic illumination area it encompasses is called “coverage discrete solid angle light beam”. Coverage discrete solid angle light beam is also referred to “ideal solid angle light beam”.

### THE FIGURES TO HELP UNDERSTANDING THE INVENTION

FIG.-1; the drawing illustrating the formation of coverage discrete solid angle light beam subject to the invention.

### REFERENCE NUMBERS

1. Basic Illumination Area
2. Unit Light Source
3. Unit Illumination Area
4. Reference Point
5. Reference Sphere
6. Projection Appearance
7. Unit Light Beam Axis
8. Unit Light Beam Solid Angle
9. Light Disk

### Detailed Explanation of the Invention

The invention is a method for forming coverage discrete solid angle light beam that is used to achieve unit areas with uniform light intensity, equal illuminance and luminance levels distribution on a basic illumination area (1) which is targeted and evaluated with unit light beams by discrete the main light beam that polyhedral lighting fixture holds, sufficient light is produced, light produced is used only in basic illumination area (1), requirements of basic illumination area (1) are met within standards, uniform illuminance and luminance levels are obtained through distribution of light at uniform intensity in basic illumination area (1), besides, no regions with weak light intensity or dark regions remain in basic illumination area (1), tetragonal light spots cover on basic illumination area (1) combines each other tetragonal modularly, have got uninterrupted integrated and uniform light coverage, sufficient light production is only for main target illumination area (1), no light pollution exists with not leakage light outside target and besides, no direct glare is occurred outside of target since the light sources not seen outside its own scope. For coverage discrete solid angle light beam, firstly it is ensured that basic illumination area (1) is divided into equal unit illumination areas (3) as many as unit light sources (2). Afterwards, a point at enough height that basic illumination area (1) is to be illuminated is selected as reference point (4) and a reference sphere (5) centered reference point (4), with a radius length enough between basic illumination area (1) and selected reference point (4) is formed. After reference sphere (5) is formed, it is ensured that perspective projection appearance (6) pertaining to unit illumination areas (3) are generated over the reference sphere (5). Later, it is secured that center of unit illumination area (3) and selected reference point (4) merge and axis of unit light axis (7) is obtained. Then, unit light source (2) locations over the reference sphere (5) at equal distance to diameter of reference sphere (5) and beyond reference point (4) in the direction of unit light beam axes (7) are determined. Following this stage, unit light beam solid angle (8) that sets out from the unit light source (2) position and moves ahead by embracing the boundaries of the projection appearance of the unit illumination area (3) on the reference sphere (5) and determines the boundary edges of unit illumination area (3) by its side surfaces. With repetition of abovementioned action steps, it is made sure that unit light beam axes (7) and unit light beam solid angles (8) that cover other unit illumination areas (3) are formed. With formation of unit light beam axes (7) and unit light beam solid angles (8), it is ensured that coverage discrete solid angle light beam is created for basic illumination area (1) and uniform light intensity, uniform illuminance and luminance levels and a homogenous lighting skill are obtained over the basic illumination area (1) accordingly.

It is concurrently secured with this invention that light axes of unit light source (2) pass through reference sphere (5) centre and intersection point of light axes are generated on sphere (5) centre, unit light beam solid angles (8) take shapes according to projection appearance (6) of unit illumination areas (3) formed over the reference sphere (5).

Again, with selection of location positions of unit light source (2) on the reference point (4) being intersection point of light axes and at equal distance within the scope of the invention, it is supplied that position planes of unit light source are able to intersect each other, so a polyhedral body may be created and multi plane body formed fixture has concave structure to reference point (4) and the unit light sources (2) deployed on each plane make convergent radiation by mentioned reference point (4) with unit lighting beams they produce in the direction of emitting axis (normal of the plane it settles on) because of their positions. With choice of unit light source (2) location positions on intersection point of light axes and at equal distance, it is provided to determine body structure of illumination fixture as a part of the invention. Unit illumination sources (2) that constitute the lighting fixture are located on reference sphere (5) within this invention.

On account of making convergent illumination to reference point (4) by unit light beams, it is secured to form a light disk (9) by intersecting on the plane formed parallel to basic illumination area (1). The space covered by this light disk (9) which are formed due to making convergent radiation to reference point (4) by unit light beams become smaller than the volume that polyhedral lighting fixture occupied in space. In addition, this light disk (9) may also be employed as light source instead of polyhedral lighting fixture too.

Another specification of the invention is that unit light beam solid angles (8) pass from intersection point of axes which is reference point (4) and independently cover their own unit illumination area (3).

Again, Light sources (2) producing unit light beams which constitute coverage discrete solid angle light beam may be fed with the values different from each other, so desired equal flux values may be created separately by them, and unit illumination areas (3) may be covered by unit light beam solid angles (8) which take form according to unit illumination areas (3) and owing to all these reasons, equal photometric threshold values may be achieved on unit areas.

With taking shape as per their perspective views in unit light sources (2) of unit illumination areas (3), unit light beam solid angles (8) and the different perspective views in unit light sources (2) of unit illumination areas (3), it is maintained to form unit light beam solid angles with a structure different each other.

Another key feature within this invention is that the uniform photometric threshold values possessed by unit light beam solid angles (8), the light flux at desired value carried in it and the solid angle shape which is different from others of unit light beam may be obtained both in unit light source (2) and on the unit illumination area (3) it targets with desired values independently from each other.

With respect to matrix representation for determining location position addresses of light sources (2), while position addresses of unit light source (2) in the polyhedral concave lighting fixture are defined in line index, position elements of unit illumination areas (3) creating basic illumination area (1) are targeted in column index.

1- This invention concerns a method for forming coverage discrete solid angle light beam that is used to obtain unit areas with uniform distribution of light intensity, illuminance and luminance levels on a illumination area (1) which is targeted and evaluated with unit light beams by disassociating the light beam that the polyhedral lighting fixture holds and evaluating it on a targeted basic illumination area, whereby sufficient light is produced, light flux produced is used only in basic illumination area (1), requirements of basic illumination area (1) are met within photometric standards, uniform illuminance and luminance levels are proved through distribution of light at uniform intensity in basic illumination area (1), besides, no regions with weak light intensity or dark regions remains in the basic illumination area (1), quadrilateral light spots falling over the basic illumination area (1) combine together modularly, ensuring continuous, uninterrupted integrated and uniform light coverage, sufficient light production is directed at meeting only the main target illumination area (1) requirements, no light pollution exists as no light is thrown outside the target and besides, no direct glare problem occurs due to the invisibility of the light source outside its own coverage area, its property is characterized by;
division of basic illumination area (1) with a quadrilateral structure into uniform unit illumination areas (3) as many as unit light sources,
designation of a reference point (4) high enough to illuminate the basic illumination area (1) as a center
formation of a reference sphere (5) centered at the reference point (4), with a radius length enough between basic illumination area (1) and designated reference point (4),
formation of projection appearance (6) pertaining to unit illumination areas (3) on the reference sphere (5) centered at the reference point (4)
connection of center of unit illumination area (3) to reference point (4) in order to obtain unit light beam axis (7)
determination of Unit light source (2) positions at equal distance from the said reference point (4) and the radius of the reference sphere (5), in the direction of the unit light beam axis (7) that were formed and beyond the reference point (4),
formation of unit light beam solid angle (8) that sets out from the unit light source (2) position and moves ahead by embracing the boundaries of the projection appearance of the unit illumination area (3) on the reference sphere (5) and determines the boundary edges of unit illumination area (3) by its side surfaces.
formation of other unit light beam solid angle (8) embracing the other related unit illumination areas (3) and unit light beam axis (7) by repeating the above mentioned process steps.
coverage discrete solid angle light beam is created according to basic illumination area (1).

2- this is the method for forming a coverage discrete solid angle light beam in compliance with claim-1, its property is characterized by the passing of the unit light beam axis (7) through the center reference sphere (5) and the formation of the intersection point of light axis at the center of the reference sphere (5).

3- this is the method for forming coverage discrete solid angle light beam in compliance with claim-1, its property is characterized by the shaping of the unit light beam solid angles (8) according to the projection appearances (6) of unit illumination areas (3) formed on the reference sphere (5).

4- the method for forming coverage discrete solid angle light beam in compliance with claim-1, its property is characterized by the positioning of the unit light sources (2) in a concave structure in relation to the reference point (4), formation of multi-plane and concave shape lighting fixture due to the position of unit light sources (2) in relation to the reference point (4) and the selection of the positions of unit light sources (2) above the reference point (4) and at an equal distance in order to enable the unit light beams produced by the unit light sources due to their positions to produce convergent radiation in relation to the reference point (4).

5- the method for forming coverage discrete solid angle light beam in compliance with claim-1, its property is characterized by the settlement of the unit light source (2) positions forming the lighting fixture with a multi plane concave structure over the reference sphere (5).

6- the method for forming coverage discrete solid angle light beam in compliance with claim-1, its property is characterized by the formation of a light disc (9) through the intersection of the light beams on a plane which is parallel to the basic illumination area (1) and formed just at the reference point as a result of the concave radiation from the unit light beams.

7- the method for forming coverage discrete solid angle light beam in compliance with claim-1, its property is characterized by the shaping of the unit light beam solid angles (8) based on the projection appearances (6) of unit illumination areas (3) over the reference sphere (5) in order to ensure that the unit light beam solid angles (8) have a structure different from each other and the projection appearances (6) of unit illumination areas (3) over the reference sphere (5) have a structure different from each other.

8- the method for forming coverage discrete solid angle light beam in compliance with claim-1, its property is characterized by the feeding of the unit light sources (2) independently from each other, operation of unit light beams independently from each other and the shaping of each unit light beam solid angle (8) according to the unit illumination area that constitutes the specific target of each such solid angle in order to obtain equal and independent photometric threshold values with the desired scales.

9- the method for forming coverage discrete solid angle light beam in compliance with claim-1, its property is characterized by the fact that the light disc (9) has a smaller size than the multi-plane concave lighting fixture in order to use the light disc (9) as a light source instead of the multi-plane concave lighting fixture.

10- the method for forming coverage discrete solid angle light beam in compliance with claim-1, its property is characterized by the fact that, with respect to matrix representation for determining location position addresses of light sources (2), while position addresses of unit light source (2) in the polyhedral concave lighting fixture are defined in line indices, position elements of unit illumination areas (3) creating basic illumination area (1) are targeted in column indices and is further characterized by the fact that the matrix representation of the unit light source position address is equal to the transposition of the matrix representation of the positional address of unit illumination areas.
